(19) United States
(12) Patent Application Publication
(10) Pub. No.: US 2018/0137660 A1
(43) Pub. Date: May 17, 2018

(54) RESPONSIVE CUSTOMIZED DIGITAL STICKERS

(71) Applicant: Microsoft Technology Licensing, LLC, Redmond, WA (US)

(72) Inventors: Juan Carlos De Abreu Rodriguez, Snoqualmie, WA (US); Wallace E. Greathouse, Kirkland, WA (US); Li Zhang, Bellevue, WA (US); Soohoon Cho, Bellevue, WA (US); Shannon Kao, Palo Alto, CA (US); Vincent Leung, Bellevue, WA (US); Arun Sacheti, Sammamish, WA (US)

(73) Assignee: Microsoft Technology Licensing, LLC, Redmond, WA (US)

(21) Appl. No.: 15/349,836

(22) Filed: Nov. 11, 2016

(51) Int. Cl. G06T 11/60

(52) U.S. Cl. CPC G06T 11/60

(57) ABSTRACT

Data regarding a base digital image and a request to generate one or more customized digital stickers for the base digital image can be received. In response to the received request, a customized digital sticker can be generated for the base digital image using results of analysis of the data regarding the base digital image, with the customized sticker including multiple visual features. The generating can include generating a customized digital sticker using a set of sticker generation rules, with the layout of multiple visual features of the digital sticker being dictated by the sticker generation rules, and with the generating of the sticker including combining the multiple visual features in the digital sticker. The digital sticker can be overlaid on the base digital image to produce a composite digital image.

### BACKGROUND

Computer systems have overlaid digital stickers on a digital photograph to enhance the digital photograph and form a composite digital image that includes the stickers and the photograph. Computer systems can then use such composite images, such as by posting them on social media sites, transmitting them in other scenarios, and displaying them on computer displays.

### SUMMARY

The tools and techniques discussed herein relate to computerized generation and use of customized digital stickers in response to a request for such a customized digital sticker. As used herein, a digital sticker is a digital visual representation (such as a digital image, template, text, and/or other digital representation of visual features) that is configured to be overlaid over a base digital image, such as a photograph, with the digital sticker being handled as a single unit in the computer system, such as by initially positioning the sticker as a single unit relative to the base digital image and/or facilitating movement of the sticker as a single unit relative to the base digital image.

In one aspect, the tools and techniques can include receiving data regarding a base digital image, which may include the base digital image itself and/or other data regarding the base digital image, such as context data. A request to generate one or more customized digital stickers for the base digital image can also be received. In response to the request, the data regarding the base digital image can be analyzed. Also, in response to the received request, a customized digital sticker can be generated for the base digital image using results of the analyzing of the data regarding the base digital image, with the customized sticker including multiple visual features. The generating can include accessing a set of computer-readable sticker generation rules in the computer system that dictate a layout of the multiple visual features. The generating can include generating a customized digital sticker using the set of sticker generation rules, with the generated digital sticker having the multiple visual features, and with the layout of the multiple visual features being dictated by the set of sticker generation rules. The tools and techniques can further include overlaying the digital sticker on the base digital image to produce a composite digital image.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described aspects may be implemented.

FIG. 2 is schematic diagram of a digital sticker overlay system.

FIG. 3 is an illustration of a computer display, showing selection of a base image for overlaying a customized digital sticker.

FIGS. 4-6 are illustrations of computer displays of navigating through different customized digital stickers for a selected base image, with FIG. 6 illustrating selection of a base image for overlaying a customized digital sticker.

FIG. 7 illustrates a computer display of a confirmation screen following selection of the customized digital sticker of FIG. 6 for the base image of FIGS. 3-6.

FIG. 8 is a flowchart of a responsive customized digital sticker overlay technique.

FIG. 9 is a flowchart of another responsive customized digital sticker overlay technique.

### DETAILED DESCRIPTION

Aspects described herein are directed to techniques and tools for responsive generation and use of customized digital stickers, which can be customized for a particular base digital image for which the digital sticker is generated. This may be done dynamically, where the digital sticker is generated in response to a digital sticker request, and this can be done in real time, such as within a minute, within thirty seconds, or within ten seconds. Such improvements may result from the use of various techniques and tools separately or in combination.

Such techniques and tools may include responding to a user providing an image to a computer service, with a request to generate a composite image that includes the provided image and one or more digital stickers. The computer service can respond by analyzing data regarding the image, such as analyzing the image itself and/or context data regarding the context for the image. For example, the analyzing can include analyzing a location where the image was taken as a photograph, user profile data for a user who is requesting the sticker or who took the image as a photograph, etc. As another example, the computer service can analyze the image to detect the features of the image, such as, but not limited to, objects, faces, animals, location, annotations, or barcodes. Based on these features and/or other analysis results, the computer service can generate personalized digital stickers and can overlay the stickers on the image, or can instruct another computer device to overlay the stickers, possibly with the aid of user input.

As an example, a user may use a phone to capture a selfie digital photograph. Upon receiving that selfie photograph, the computer service can then generate a set of stickers based on the features detected in the image. This could include, for example, stickers based on age of the user in the photograph, emotion of the user in the photograph, or how much the user in the photograph looks like a particular celebrity.

Another example can include a user taking a photograph of a landscape with a computer device. Upon receiving the photograph, the computer service can generate a set of stickers depending on the content of an image. For instance, if a lake is detected with image analysis, the computer service may return stickers of fish, boats, a Loch Ness Monster, etc.

As yet another example, a user may take a picture of the Eiffel Tower with a device, and provide that picture to the computer service. The service can analyze the image and create a ‘passport-like’ stamp that includes the word “Paris,” the date, and a silhouette of the Eiffel Tower.

The technique can include, not only filtering down the set of stickers based on the features of the provided image, but actually generating personalized stickers on the fly, responsive to a request for the stickers. As an example, the user could upload a selfie which the computer service determines looks 87% like a first celebrity, 54% like a second celebrity, and 45% like a third celebrity. The computer service can return three personalized stickers with, each having a picture of a celebrity and the match percentage for that celebrity.

In contrast with other techniques where overlay stickers are simply selected from a finite number of existing digital stickers, the tools and techniques described herein can utilize stored computer-readable rules to generate new customized digital stickers with combined visual features on the fly. Doing so can substantially reduce the amount of computer resources to be used for providing digital stickers, as compared to computer resources that would be used to store numerous different pre-made digital stickers having different combinations of visual features and retrieving appropriate pre-made digital stickers upon request. The tools and techniques discussed herein for responsive customized digital sticker overlays can also provide flexibility in adapting to new situations that may yield different combinations of visual features in a digital sticker, according to stored rules, even if such specific combinations may not have been contemplated previously. Thus, tools and techniques here for responsive customized digital sticker overlays can also provide improved usability of the computer system in overlaying digital stickers on base images by customizing the digital stickers for the underlying base digital images.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

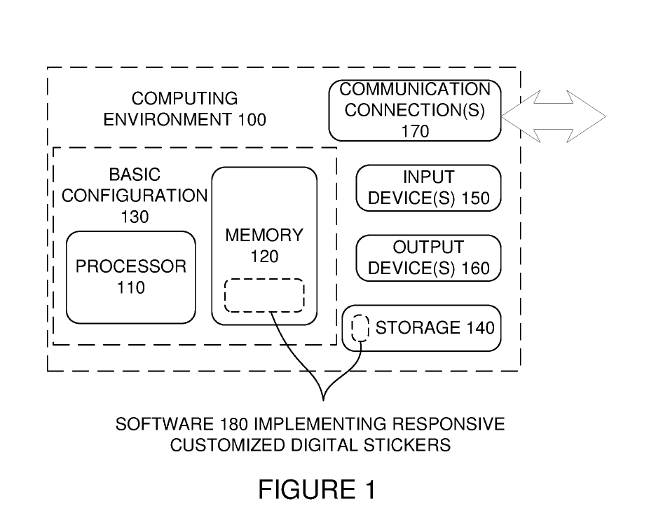

Techniques described herein may be used with one or more of the systems described herein and/or with one or more other systems. For example, the various procedures described herein may be implemented with hardware or software, or a combination of both. For example, the processor, memory, storage, output device(s), input device(s), and/or communication connections discussed below with reference to FIG. 1 can each be at least a portion of one or more hardware components. Dedicated hardware logic components can be constructed to implement at least a portion of one or more of the techniques described herein. For example and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

FIG. 1 illustrates a generalized example of a suitable computing environment (100) in which one or more of the described aspects may be implemented. For example, one or more such computing environments can be used as a client device or a computer device in a sticker service or a data service. Generally, various different computing system configurations can be used. Examples of well-known computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment (100) is not intended to suggest any limitation as to scope of use or functionality of the invention, as the present invention may be implemented in diverse types of computing environments.

With reference to FIG. 1, various illustrated hardware-based computer components will be discussed. As will be discussed, these hardware components may store and/or execute software. The computing environment (100) includes at least one processing unit or processor (110) and memory (120). In FIG. 1, this most basic configuration (130) is included within a dashed line. The processing unit (110) executes computer-executable instructions and may be a real or a virtual processor. In a multi-processing system, multiple processing units execute computer-executable instructions to increase processing power. The memory (120) may be volatile memory (e.g., registers, cache, RAM), non-volatile memory (e.g., ROM, EEPROM, flash memory), or some combination of the two. The memory (120) stores software (180) implementing responsive customized digital sticker overlays. An implementation of responsive customized digital sticker overlays may involve all or part of the activities of the processor (110) and memory (120) being embodied in hardware logic as an alternative to or in addition to the software (180).

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more aspects of the technology discussed herein. Distinction is not made between such categories as “workstation,” “server,” “laptop,” “handheld device,” etc., as all are contemplated within the scope of FIG. 1 and reference to “computer,” “computing environment,” or “computing device.”

A computing environment (100) may have additional features. In FIG. 1, the computing environment (100) includes storage (140), one or more input devices (150), one or more output devices (160), and one or more communication connections (170). An interconnection mechanism (not shown) such as a bus, controller, or network interconnects the components of the computing environment (100). Typically, operating system software (not shown) provides an operating environment for other software executing in the computing environment (100), and coordinates activities of the components of the computing environment (100).

The memory (120) can include storage (140) (though they are depicted separately in FIG. 1 for convenience), which may be removable or non-removable, and may include computer-readable storage media such as flash drives, magnetic disks, magnetic tapes or cassettes, CD-ROMs, CD-RWs, DVDs, which can be used to store information and which can be accessed within the computing environment (100). The storage (140) stores instructions for the software (180).

The input device(s) (150) may be one or more of various different input devices. For example, the input device(s) (150) may include a user device such as a mouse, keyboard, trackball, etc. The input device(s) (150) may implement one or more natural user interface techniques, such as speech recognition, touch and stylus recognition, recognition of gestures in contact with the input device(s) (150) and adjacent to the input device(s) (150), recognition of air gestures, head and eye tracking, voice and speech recognition, sensing user brain activity (e.g., using EEG and related methods), and machine intelligence (e.g., using machine intelligence to understand user intentions and goals). As other examples, the input device(s) (150) may include a scanning device; a network adapter; a CD/DVD reader; or another device that provides input to the computing environment (100). The output device(s) (160) may be a display, printer, speaker, CD/DVD-writer, network adapter, or another device that provides output from the computing environment (100). The input device(s) (150) and output device(s) (160) may be incorporated in a single system or device, such as a touch screen or a virtual reality system.

The communication connection(s) (170) enable communication over a communication medium to another computing entity. Additionally, functionality of the components of the computing environment (100) may be implemented in a single computing machine or in multiple computing machines that are able to communicate over communication connections. Thus, the computing environment (100) may operate in a networked environment using logical connections to one or more remote computing devices, such as a handheld computing device, a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment (100), computer-readable storage media include memory (120), storage (140), and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various aspects. Computer-executable instructions for program modules may be executed within a local or distributed computing environment. In a distributed computing environment, program modules may be located in both local and remote computer storage media.

For the sake of presentation, the detailed description uses terms like “determine,” “analyze,” “generate,” “produce,” “receive,” “send,” “retrieve,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Digital Sticker Overlay System

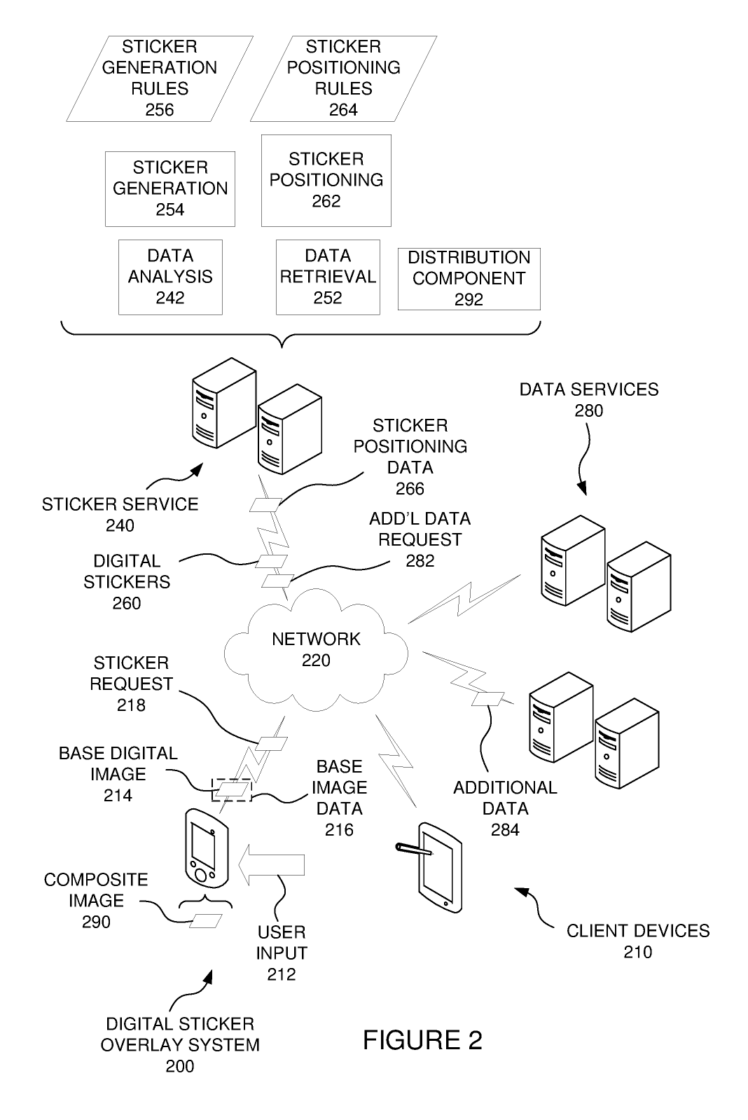

FIG. 2 is a block diagram of a digital sticker overlay system (200) in conjunction with which one or more of the described aspects may be implemented.

Communications between the various devices and components discussed herein can be sent using computer system hardware, such as hardware within a single computing device, hardware in multiple computing devices, and/or computer network hardware. A communication or data item may be considered to be sent to a destination by a component if that component passes the communication or data item to the system in a manner that directs the system to route the item or communication to the destination, such as by including an appropriate identifier or address associated with the destination. Also, a data item may be sent in multiple ways, such as by directly sending the item or by sending a notification that includes an address or pointer for use by the receiver to access the data item. In addition, multiple requests may be sent by sending a single request that requests performance of multiple tasks.

Each of the components of FIGS. 1-2 includes hardware, and may also include software. For example, such a component can be implemented entirely in computer hardware, such as in a system on a chip configuration. Alternatively, a component can be implemented in computer hardware that is configured according to computer software and running the computer software. The components can be distributed across computing machines or grouped into a single computing machine in various different ways. For example, a single component may be distributed across multiple different computing machines (e.g., with some of the operations of the component being performed on one or more client computing devices and other operations of the component being performed on one or more machines of a server).

A. System Component Overview

The components of the digital sticker overlay system (200) illustrated in FIG. 2 will now be discussed.

1. Client Devices

Components of the digital sticker overlay system (200) can include client devices (210), which can be computing devices that are configured to receive user input (212) selecting a base digital image (214) upon which to apply one or more digital stickers. For example, a client device (210) may be a smartphone, a tablet, a laptop, a smart watch, and/or some other type of computing device.

The client device (210) can be programmed to respond to the user input (212) selecting the base digital image (214) by sending base image data (216), which is data regarding the base digital image (214). The base image data (216) can include the base digital image (214) itself and/or other data regarding visual features in the base digital image. The base image data (216) may include other data regarding the base digital image (214), such as context data regarding the context for the base digital image (216) (e.g., in the form of metadata or other data from the client device (210)). For example, the context data may include data indicating the time the base digital image (214) was taken as a photograph; data indicating a current time zone for the client device (210); data about a location in which the base digital image (214) was taken as a photograph (such as altitude data, global positioning system data, address data, etc.; other sensor data from the client device (210), such as pedometer data, battery status data, and/or other data from device sensors (pedometer, accelerometer, gyroscope, magnetometer, battery status sensor, etc.); and/or data about a user profile that was active when the base digital image (214) was taken as a photograph and/or when the user input (212) was received to select the base digital image (214) for overlaying a digital sticker. The client device (210) can also respond by sending a computer-readable sticker request (218) over the network (220) to a computerized sticker service (240). The sticker request (218) may be sent separately from the base image data (216) or together with the base image data (216). Indeed, the sticker request (218) and the base image data (216) may be the same data package, so long as the system recognizes that data package as the request for a customized digital sticker for the base digital image (214). If the sticker request (218) is sent separately from the base image data (216), then the sticker request (218) can include data that references the base image data (216) (such as by including a common identifier for the sticker request (218) and the base image data (216)). For example, the sticker request (218) can reference the base digital image (214) itself.

A client device (210) may obtain a base digital image (214) in different ways, such as by receiving the base digital image (214) in a digital communication, or taking a photograph and saving the photograph as the base digital image. In some scenarios, the base digital image (214) may be provided to the sticker service (240) from a different device from the client device (210) that sends the sticker request (218). For example, the base digital image (214) may be stored in an online server, and the sticker request (218) may include a link to the base digital image (214), or the sticker request (218) may be sent from one client device (210), and the base digital image (214) may be sent from another client device (210).

2. Sticker Service and Data Services

The sticker service (240) can be programmed to respond to sticker requests (218) and base digital images (214). The sticker service (240) can include one or more server computers. The sticker service (240) can include a data analysis component (242), which can be configured to analyze base image data (216); a data retrieval component (252), which can be configured to retrieve data; a sticker generation component (254), which can be configured to generate digital stickers (260) using computer-readable sticker generation rules (256); and a sticker positioning component (262), which can be configured to determine positioning of digital stickers (260) relative to base images (214) using computer-readable sticker positioning rules (264).

The data analysis component (242) can provide results of its analysis of the base image data (216) to the sticker generation component (254). As an example, the sticker generation component (254) may receive the base image data (216) and provide a portion of the base image data (216) to the data analysis component (242) to perform analysis on the base image data (216). For example, the data analysis component (242) may perform image analysis of the base digital image (214). Such analysis may include matching visual features of the base digital image (214) to patterns from existing images, or from set rules or patterns that have been previously extracted from previous images. For example, the data analysis component (242) may invoke existing image analysis services to perform image analysis, and to return data indicating categories of items appearing in the base digital image (214), particular features of those items, and locations of the items in the base digital image (214). Such image analysis may include facial recognition, which can include recognizing human faces in the base digital image, and may also include recognition of particular individuals, or particular expressions of the face(s). Such facial recognition analysis may also include recognizing an age of a face appearing in the base digital image (214). Accordingly, as a few examples, the image analysis may include recognizing faces of individuals, recognizing ages of faces (such as in estimating that a face belongs to a forty-year old person, when the person is actually thirty years old), recognizing how much a particular face looks like another face (such as a percentage of similarity between a face in the base digital image (214) and a celebrity), and/or recognizing expressions on a human face.

The image analysis may include categorizing particular visual features in the base digital image, such as landmarks, landscapes (lakes, rivers, etc.), types of food, or any of numerous other types of items. The processes can generate scores that rate the similarity of the patterns of the visual features in the base digital image (214) to pre-existing patterns, to identify types of items in the base digital image, along with values for levels of confidence in such identifications. Such image analysis can be performed by existing computer services. It is to be recognized that such analyses may include some rate of errors. The data analysis component (242) may analyze other base image data (216), such as data regarding time and/or location data for images taken as photographs.

The data analysis component (242) can provide the results of its analysis to the sticker generation component (254). The sticker generation component (254) and/or the data analysis component (242) may also invoke the data retrieval component (252) to send out additional data requests (282) to retrieve additional data from data services (280) that are separate from the sticker service (240). The data services (280) can be configured to respond with additional data (284), which can be received by the data retrieval component (252) and analyzed by the data analysis component (242). As an example, this additional data may include data from search engines, news server sites, social media sites, sites providing information in articles, or other data-providing sites, which can be remote from the sticker service (240). As a few examples, the additional data (284) may include data regarding public holidays, public events (such as an election date, etc.), local events (movies, concerts, sports games, etc.), consumer reviews, each of which can be matched to times and/or locations received from the client device (210) in the base image data (216). For example, the data retrieval component (252) may send additional data requests (282) as specific application programming interface calls and/or as submitted queries to the data services (280), identifying specific data and/or types of data being requested. For example, the data services may include general search engines, computer services that track locations and times of events, geographical mapping services, and/or other data providing computer services. The additional data (284) may be in any of various computer-readable formats, such as lists of data items, messages, files, database records, etc. The data analysis component (242) may analyze the returned additional data (284) from the data services (280), and may provide the results of its analysis to the sticker generation component (254). For example, analysis of the additional data may allow generation of different stickers for different seasons of the year (or for particular holidays) based on the additional data (284) and on time data from the client device (210), generation of election stats stickers during election season based on the additional data and on time data from the client device (210), generation of a recent movie poster sticker based on the additional data (284) and on location and time data from the client device (210), generation of a review score sticker for a restaurant if the user is inside a certain restaurant given the location data from the client device (210).

The results of the analysis of the base image data (216) and the additional data (284) can be used by the sticker generation component (254) in generating digital stickers (260) according to the sticker generation rules (256) in response to the sticker request (218). The analysis results may also be used by the sticker positioning component (262) in positioning stickers (260) relative to base digital images (214) according to the sticker positioning rules (264).

The sticker generation rules (256) and the sticker positioning rules (264) can take various different forms, so long as the rules are computer-readable and can be recognized and adhered to by the sticker generation component (254) or the sticker positioning component (262). For example, the rules may be in the form of object code, scripts, image templates, markup language code, combinations of these, and/or one or more other formats. The sticker generation rules (256) may include and/or reference content for visual items to be included in the stickers. For example, the sticker generation rules (256) may include text, such as text located in templates, or located in rules to be executed in generating phrases to be included as visual features of the digital stickers (260). The sticker generation rules may also include and/or reference textual and/or non-textual graphics to be included as visual features in generated digital stickers (260). Also, the additional data (284) retrieved from the data services (280) can include textual and/or non-textual visual features to be included in the digital stickers (260).

The sticker generation component (254) of the sticker service (240) can combine multiple visual features in a digital sticker (260) in response to the sticker request (218). For example, the sticker generation component (254) can combine multiple different pre-existing visual features. Also, some visual features may instead be generated specifically for a customized digital sticker (260). For example, the sticker generation rules (256) may include a formula to calculate a numeric value, and a representation of that calculated numeric value may be included in a digital sticker (260). Thus, some of the visual features for the digital sticker (260) may be generated after the sticker service (240) receives the sticker request (218), while other visual features may be pre-existing features that are selected by the sticker service (240) using the base image data (216) and/or the additional data (284).

As an example, the sticker generation component (254) may combine multiple pre-existing textual features to form one or more phrases to be included in a digital sticker (260). As another example, the sticker generation component (254) may combine text representing values from the additional data (284) into a template from the sticker generation rules (256) to form a digital sticker (260). As yet another example, the sticker generation component (254) may combine multiple existing graphical images into a layout defined by the sticker generation rules (256) to form a digital sticker (260). As yet another example, the sticker generation component (254) can combine one or more textual phrases with one or more graphical features such as drawings and/or photographs in a layout defined by the sticker generation rules (256) to form a digital sticker (260). The sticker generation component (254) may also change one or more colors of one or more visual features of the digital sticker (260), such as to provide contrast between colors of the digital sticker (260) and colors of the base digital image (214) in an area around the digital sticker (260). Such colors may be determined after the positioning component (262) positions the digital sticker (260) on the base digital image (214). The digital sticker (260) can be defined with underlying computer-readable data, such as textual data for textual phrases, location data for locations of features within the digital sticker, image data such as encoded graphical data for graphical features of the sticker. A digital sticker (260) may be defined in whole or in part in a lossy or losless digital image format, such as a vector graphics format and/or a non-vector image format, such as a SVG file format, a JPG file format, a PNG file format, a bitmap file format, etc.

The sticker positioning component (262) can determine a position relative to the base digital image (214) for each of the digital stickers (260), according to the sticker positioning rules (264). The sticker positioning component (262) can use results from the data analysis component (242). For example, an image analysis of the base digital image (214) can indicate positions of identified visual features in the base digital image (214). The sticker positioning rules (264) can dictate locations for digital stickers (260) to be placed relative to visual features in the base digital image (214) to which the digital stickers (260) are relevant. The positioning rules (264) may also dictate avoiding placing the digital stickers (260) over other prominent visual features that are identified in the image analysis, if possible. For example, if a digital sticker (260) pertains to an identified human face in the base digital image (214), then the sticker positioning rules (264) for that type of sticker (260) can indicate that the digital sticker (260) is to be placed a certain distance from an outside edge of that face. The sticker positioning rules (264) may also dictate that the that the sticker is to be placed above the face, unless doing so would place the sticker (260) so that it covers all or part of another recognized face in the base digital image (214), or there is not room in the base digital image (214) above the recognized face. In those alternative scenarios, the sticker positioning rules (264) may set out other positions for the sticker (260), with a priority order for such positions. The sticker positioning rules (264) may also dictate orientation and/or size of all or part of the digital sticker (260). As an example, a sticker (260) may include an arrow that points in the direction of a visual feature of the base digital image (214) to which the digital sticker (260) pertains. In sum, by applying the sticker positioning rules (264) to data for the sticker (260) and the base digital image (214), the sticker positioning component (262) can determine a position of the digital sticker (260) relative to the base digital image (214), and may also determine a size and orientation of some or all features in the digital sticker (260).

The sticker service (240) can be configured to return the generated digital stickers (260) and the sticker positioning data (266) to the client device (210) in response to the sticker request (218) and/or the sending of the base digital image (214). The client device (210) can use the sticker positioning data (266) to overlay the digital sticker(s) (260) on the base digital image (214) using the sticker positioning data (266), to form a composite image (290), which includes the digital sticker(s) (260) overlaid on the base image (214).

The digital sticker overlay system (200) may be configured in different ways. For example, the sticker generation component (254) may be distributed among multiple different computer systems (which may include the client devices (210)). For example, there may be multiple sub-components in different computer systems, with each sub-component being configured to generate a different type of digital sticker (260), and with each sub-component having its own subset of the sticker generation rules (256). The sticker positioning component (262) may likewise be distributed. Indeed, in such a distributed system, each sub-component of the sticker generation component (254) may be co-located with a corresponding sub-component of the sticker positioning component (262). Such a distributed system may be beneficial for allowing extensibility.

In such a distributed system, the sticker service (240) may include a distribution component (292) that receives sticker requests (218) and distributes corresponding sub-requests to the sub-components, requesting that they generate and return digital stickers (260), as well as positions for those digital stickers (260) relative to the base digital image (214). The distribution component (292) can be part of the data analysis component (242), the sticker generation component (254) and/or the sticker positioning component (262). The distribution component (292) can process results from the data analysis component (242), and can use such results to select a subset of the sub-components for generating and positioning digital stickers (260) in response to a particular sticker request (218). Such distributed handling of the request (218) to provide digital sticker(s) (260) for a provided base digital image (214) may be performed in response to the request (218).

The client devices (210), the sticker service (240), and data services (280) may be located remotely from each other with communications between these overall components being conducted over the network (220). Likewise, sub-components of each of the client devices (210), the sticker service (240), and data services (280) may located remotely from each other. For example, all or part of the data analysis component (242) may be located remotely from the sticker generation component (254), with communications between the sticker generation component (254) and all or part of the data analysis component (242) being conducted over the network (220).

B. Examples of Customized Digital Stickers

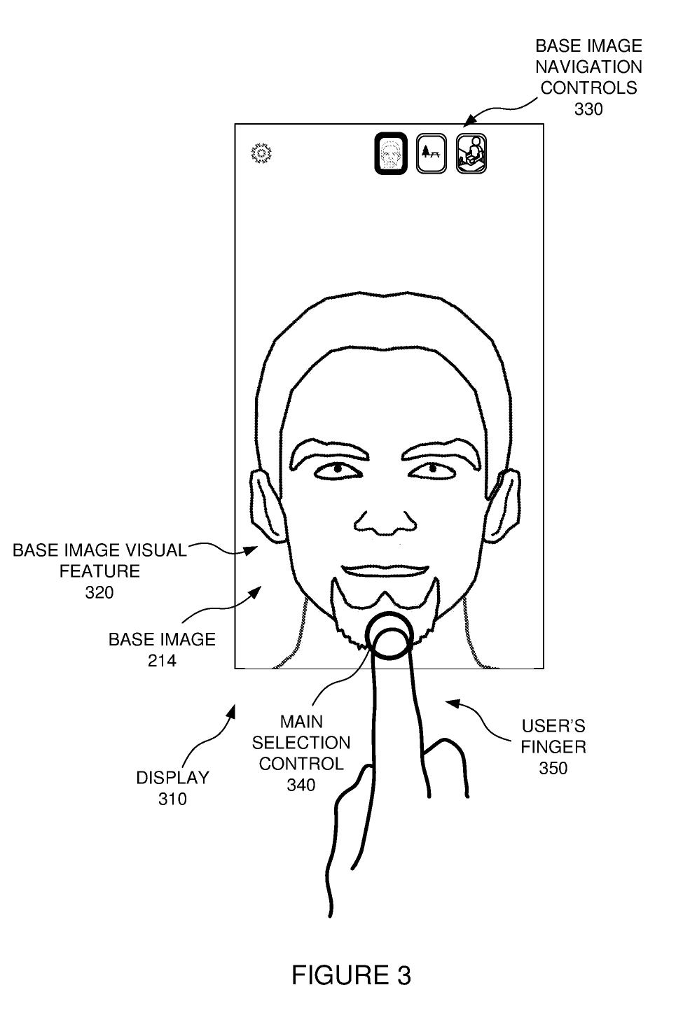

An example of a user interface scenario for overlaying responsive customized digital stickers will now be discussed with reference to FIGS. 3-6. Referring to FIG. 3, a computer display (310) of a device is shown with a user interface display for a digital sticker application, such as an application on a client device, such as a smartphone or tablet computer. As illustrated, the computer display (310) is a touch screen displaying a base image (214) having a base image visual feature (320), which is a human face. However, other different types of devices and/or interfaces may be used. As illustrated, the base image (214) is a line drawing for the sake of simplicity in this description, but it may be a photograph or some other type of image. The base image (214) may also include additional features besides the face. Also, particular features of the face may be considered to be different visual features within the main visual feature. For example, the mouth, eyes, ears, nose, etc. may each be recognized as separate visual features, along with recognizing the overall face as a visual feature (320). Additionally, the tools and techniques discussed herein may be used with many different types of visual features other than faces.

The display (310) can show base image navigation controls (330), which can be selected with a user's finger (350) on the touch screen display (310) to navigate between different base images (214). Other user input gestures may also be used for such navigation, and for other types of user input discussed herein. For example, the user input may include swipes on the display (310) using touch input, or cursor input to navigate between different base images (214). Other types of input such as voice input or non-touch gestures may also be used.

The display (310) can further include a displayed main selection control (340), which can be selected by user input (touch input, mouse click, etc.) to select the base image (214) for having digital stickers overlaid on that base image (214). In response, a sticker request can be sent with the base image (214) to a computerized sticker service, as discussed above.

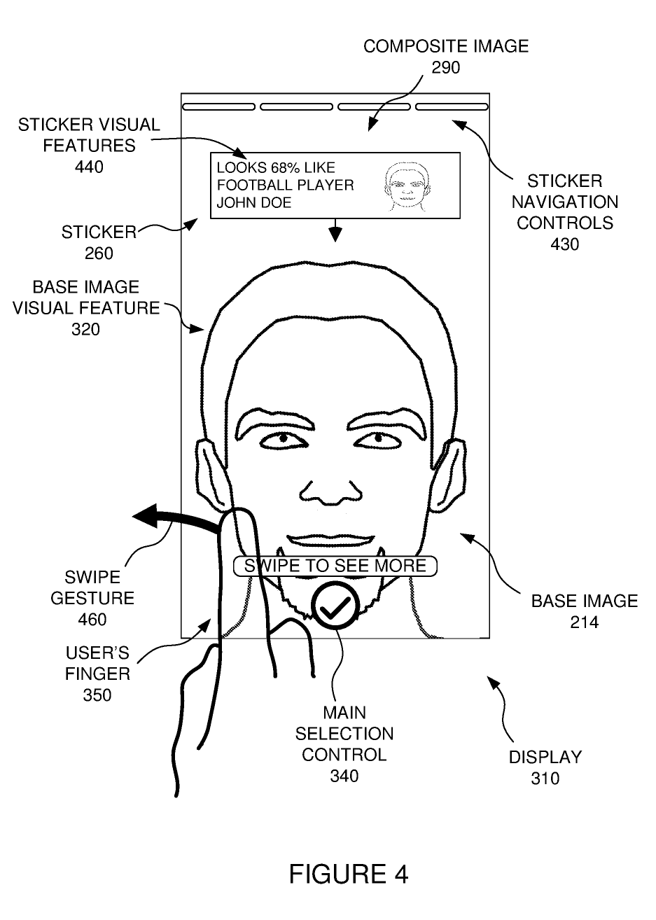

Referring to FIG. 4, the sticker service can return the digital stickers (260) in response to the sticker request, and the client device can overlay the stickers (260) on the base image (214) to produce the composite image (290) that includes the sticker (260) overlaid on the base image (214), all in response to the user input selection of the main selection control (340), as illustrated in FIG. 3. Alternatively, a remote sticker service may overlay the stickers (260) on the base image (214) to form composite images (290), and the client device can receive those composite images (290). The generation and/or display of one or more digital stickers (260) with the base image (214) may be done as a real time response to the selection of the main selection control (340), such as within a minute of the selection of the main selection control (340), within thirty seconds of the selection of the main selection control (340), or within ten seconds of the selection of the main selection control (340). The display (310) showing the composite image (290) as in FIG. 4 can also include sticker navigation controls (430), which can be selected to navigate between views of different stickers (260) overlaid on the base image (214). In the view of FIG. 4, the main selection control (340) can be selected to select the displayed composite image (290). Also in this view, user input may be provided to modify the sticker (260) as a unit, such as by moving the sticker (260) relative to the base image (214) and/or resizing the sticker (260).

In this view of FIG. 4, a single sticker (260) is illustrated, although in other scenarios multiple stickers (260) may be overlaid on a single base image (214). The sticker (260) of FIG. 4 includes multiple different visual features (440) that were combined in generating the sticker (260) in response to the selection of the main selection control (340), illustrated in FIG. 3. The sticker (260) of FIG. 4 includes a graphical depiction of a celebrity's face, and the textual statement, “Looks 68% like football player John Doe.” This indicates that an analysis of the facial features of the detected face in the base image (214) had a 68% correspondence with the facial features of a celebrity, who is a football player named John Doe (whose picture is shown to the right of the text). In this sticker, existing text of a template statement “Looks ______% like ______ ______” can combined with text to fill the blanks (indicated by underlining here for convenience in the description). The first blank can be filled in with a number for the percentage of the similarity, as scored by an existing facial recognition and comparison algorithm that can be invoked through an application programming interface. The second blank can be filled in with text stating a main occupation for the celebrity, and a third blank can be filled in with the celebrity's name, both of which can be retrieved as additional data, such as from the facial recognition service, as discussed above. Thus, this textual statement in the sticker (260) of FIG. 4 can include multiple different visual features (440) that are combined to form the phrase appearing in the sticker (260). These textual visual features (440) are also combined with a non-textual graphical feature, which is an image depicting the face of the celebrity John Doe. Thus, the multiple visual features of the textual phrase and the non-textual graphical feature are all combined and included in the single sticker (260), which can be included as a unit overlaid on the base image (214) to form the composite image (290).

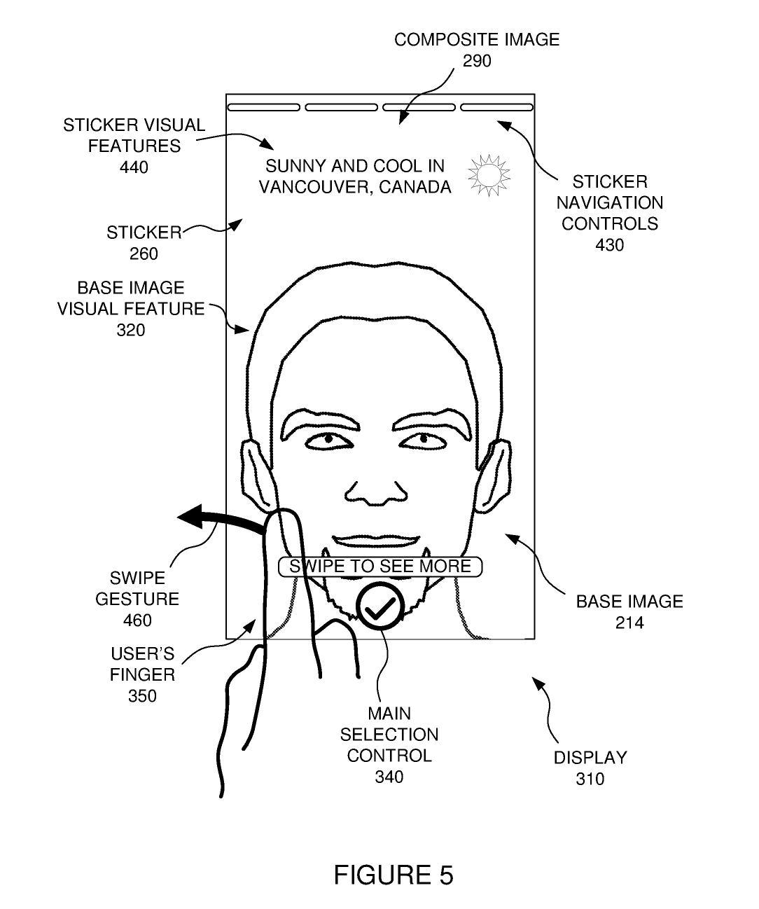

The user's finger (350) can perform a swipe gesture (460) along the display (310) of FIG. 4 to navigate to a different composite image (290), illustrated in FIG. 5. The display (310) of FIG. 5 is the same as in FIG. 4, except with a different sticker (260). The sticker of FIG. 5 includes the phrase “Sunny and cool in Vancouver, Canada.” For this phrase, the data analysis component of the sticker service could have recognized the location and time of the photograph in the base image data. In response to such information, the sticker generation component could invoke the data retrieval component to retrieve weather data for that location and time from a data service. The information could then be identified and included in a textual template, such as “______ in ______”, with the first blank being filled in with the weather description from the data service, and with the second description being filled in with the city and country, from the base image data or from a mapping data service using location data (such as global position system data) from the base image data. The sticker (260) can also include a graphical image that corresponds to the weather (an image depicting a drawing of the sun in this example). This sticker (260) could also include additional visual features, such as text indicating the date the picture was taken. For example, that graphical image may be included in the sticker generation rules for the weather sticker, or it may be retrieved from a location outside of the sticker generation rules, such as from the weather data service. The sticker generation component could combine the textual components and the graphical weather image to form the sticker (260), and the sticker service could return the sticker (260) to be overlaid on the base image (214) and displayed on the computer display (310).

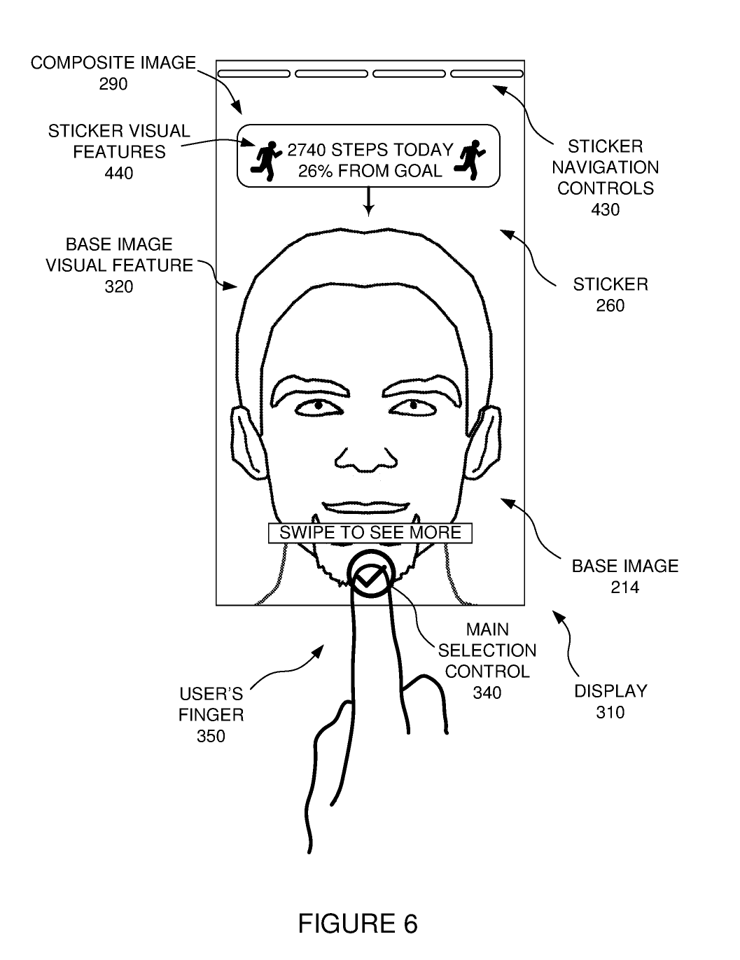

The user's finger (350) can again perform a swipe gesture (460) along the display (310) of FIG. 5 to navigate to yet another composite image (290), illustrated in FIG. 6. The display (310) of FIG. 6 is the same as in FIGS. 4-5, except with yet another different sticker (260). Visual features (440) of the sticker (260) illustrated in FIG. 6 include textual features in the phrase “2740 steps today 26% from goal”, describing the status of the user's activity tracking data (such as activity tracking data associated with the user's profile and/or device). The activity tracking data for the daily steps goal and the number of steps taken may be retrieved from the client device in the base image data (216), or it may be retrieved from another computer environment. For example, this activity tracking data may be retrieved from a data service (280), with the request for the data indicating a user profile that is active on the client device that requested the stickers (260). In one implementation, this activity tracking data may only be provided and the corresponding activity tracking sticker may only be shown if the image analysis of the base image (214) indicates that the face of the user corresponding to the active user profile on the client device (210) is recognized in the base image (214). The image tracking data can be combined with the text in a phrase template in the sticker generation rules to produce the phrase “2740 steps today 26% from goal”, and this phrase may be combined with one or more graphical images (such as images of a person walking or running, as illustrated in FIG. 6) as part of the sticker (260).

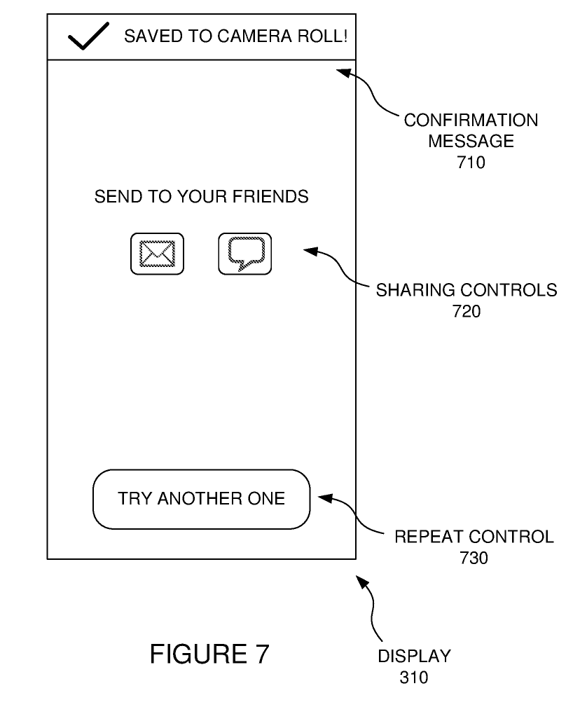

As illustrated in FIG. 6, the user's finger (350) can select the main selection control (340) on the display (310) to select the composite image (290) illustrated in FIG. 6. In response, the composite image (290) can be saved to a storage location (such as the camera roll) on the client device, as indicated in a confirmation message (710) on the display (310), as illustrated in FIG. 7. The display (310) can also include sharing controls (720) that can be selected to send the composite image (290), such as in a text message, an email message, or a social media sharing service. Additionally, the display (310) can include a repeat control (730) that can be selected to repeat the process illustrated in FIGS. 3-7, allowing selection of different composite images using the same base image or a different base image.

Many other different types of customized stickers can be generated, with the customized stickers combining data, such as image data, image analysis data, location data, time data, data regarding events (e.g., a sticker indicating a particular musical group when a picture is taken of a music concert at a time and place that additional data from a data service indicates is the time and place for a concert by that musical group, a sticker indicating estimated ages for identified faces in a base image, etc.).

### III. Computerized Responsive Customized Digital Sticker Overlay Techniques

Responsive customized digital sticker overlay techniques will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable memory may have computer-executable instructions embodied thereon that, when executed by at least one processor, cause at least one processor to perform the technique. The techniques discussed below may be performed at least in part by hardware logic.

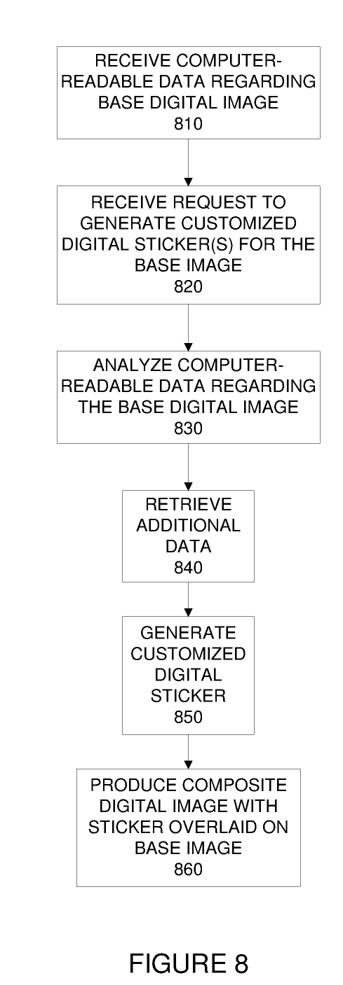

Referring to FIG. 8, a responsive customized digital sticker overlay technique will be described. The technique can include receiving (810) data regarding a base digital image, and receiving (820) a request to generate one or more customized digital stickers for the base digital image. The technique can further include analyzing (830) the computer-readable data regarding the base digital image. In response to the analyzing (830), the technique can optionally include retrieving (840) additional computer-readable data using results of the analyzing of the computer-readable data regarding the base digital image (such as if sticker generation rules indicate that additional data is to be retrieved). The additional data can include digital data for one or more visual features. The technique can further include generating (850) a customized digital sticker for the base digital image in response to the receiving of the request to generate the one or more digital stickers. The customized digital sticker can include a set of the multiple visual features. The generating (850) can include accessing a set of computer-readable sticker generation rules in the computer system that dictate a layout of the set of the multiple visual features, and generating the customized digital sticker using the set of sticker generation rules. The generating (850) of the digital sticker can include combining the set of multiple visual features in a layout that is dictated by the set of sticker generation rules. Also, the generating (850) of the customized digital sticker can use the results of the analyzing of the computer-readable data regarding the base digital image and can optionally use the additional data (such as if sticker generation rules indicate that additional data is to be used). The technique can also include producing (860) a composite digital image having the digital sticker overlaid on the base digital image, with the producing of the composite digital image including overlaying the digital sticker on the base digital image.

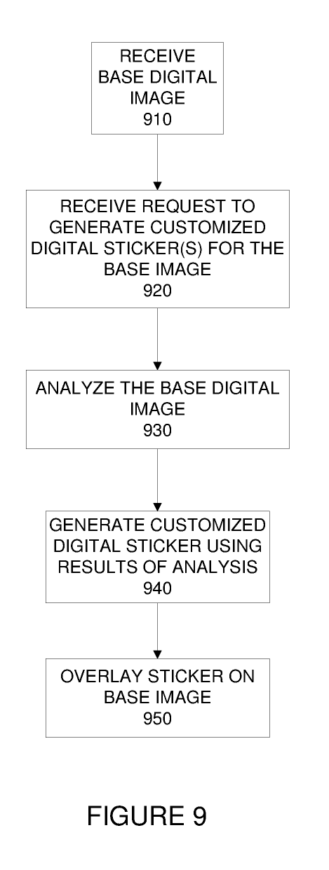

One or more of the features of the following paragraphs may be used with the technique of FIG. 8 and/or the technique discussed below with reference to FIG. 9, in any combination with each other.

The generating (850) of the customized digital sticker can include generating a textual phrase. The generating of the textual phrase can include combining multiple textual portions of the phrase. The textual portions of the textual phrase can each be a visual feature in the set of multiple visual features that are combined in the customized digital sticker.

The combining of the multiple visual features in the layout of the customized digital sticker can include overlaying one feature of the set of multiple features on another feature of the set of multiple features. For example, this may include overlaying text on a graphical image, or placing a border on a graphical image.

The set of multiple visual features combined in the customized digital sticker can include a textual feature and a non-textual graphical feature.

The analyzing of the computer-readable data regarding the base digital image can include performing image analysis on the base digital image. The performing of the image analysis can include categorizing a visual feature of the base digital image as a type of item (e.g., a human face, a building, a lake, a mountain, apples, a street, the moon, etc.). The visual feature of the base digital image can be a human face, and the performing of the image analysis can include performing a facial recognition process on the visual feature of the base digital image.

The data regarding the base digital image can include data indicating a time that the base digital image was taken as a photograph, and data indicating a location where the base digital image was taken as a photograph. The additional computer-readable data can include data that is descriptive of one or more events, which is proximate in time to the indicated time that the base digital image was taken as a photograph and proximate in location to the indicated location where the base digital image was taken as a photograph (such as data indicating the weather at a particular location and time, or data indicating a concert at a particular location and time).

The retrieving of the additional computer-readable data can include retrieving the additional data from a remote computer service.

The technique of FIG. 8 can further include receiving a user input instruction to move the digital sticker relative to the base digital image in the composite digital image, and in response to the receiving of the user input instruction, moving the digital sticker relative to the base digital image in the composite digital image.

The customized digital sticker can be termed a first customized digital sticker, and the set of the multiple visual features can be termed a first set of the multiple visual features. The technique can further include generating a second customized digital sticker for the base digital image in response to the receiving of the request to generate one or more customized digital stickers, with the second customized sticker including a set of the multiple visual features. The generating of the second sticker can include accessing the set of computer-readable sticker generation rules in the computer system, with the set of computer-readable sticker generation rules dictating a layout of a second set of the multiple visual features. The generating of the second sticker can further include generating the second customized digital sticker using the set of sticker generation rules. The second generated digital sticker can have the second set of the multiple visual features. The generating of the second digital sticker can include combining the second set of the multiple visual features in a layout that is dictated by the set of sticker generation rules. The composite digital image can include the first digital sticker and the second digital sticker overlaid on the base digital image.

Referring now to FIG. 9, another responsive customized digital sticker overlay technique will be described. The technique can include receiving (910) a base digital image, and receiving (920) a request to generate one or more customized digital stickers for the base digital image. The technique can also include, in response to the request, analyzing (930) the base digital image, with the analyzing comprising detecting one or more visual features of the base digital image. The technique can further include generating (940), in response to the received request, a customized digital sticker for the base digital image using results of the analyzing of the base digital image, with the customized sticker including multiple visual features. The generating (940) can include accessing a set of computer-readable sticker generation rules in the computer system that dictate a layout of the multiple visual features. The generating (940) can further include generating a customized digital sticker using the set of sticker generation rules, with the generated digital sticker having the multiple visual features, and with the layout of the multiple visual features being dictated by the set of sticker generation rules. The technique of FIG. 9 can further include overlaying (950) the digital sticker on the base digital image to produce a composite digital image having the digital sticker overlaid on the base digital image.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer system comprising:
at least one processor; and
memory comprising instructions stored thereon that when executed by at least one processor cause at least one processor to perform acts comprising:
receiving computer-readable data regarding a base digital image;
receiving a request to generate one or more customized digital stickers for the base digital image;
analyzing the computer-readable data regarding the base digital image;
in response to the analyzing of the computer-readable data regarding the base digital image, retrieving additional computer-readable data using results of the analyzing of the computer-readable data regarding the base digital image, with the additional data comprising digital data for one or more visual features;
generating a customized digital sticker for the base digital image in response to the receiving of the request to generate the one or more digital stickers, with the customized sticker comprising a set of multiple visual features, and with the generating comprising:
accessing a set of computer-readable sticker generation rules in the computer system that dictate a layout of the set of the multiple visual features; and
generating the customized digital sticker using the set of sticker generation rules, with the generating of the digital sticker comprising combining the set of the multiple visual features in a layout that is dictated by the set of sticker generation rules, and with the generating of the customized digital sticker using the additional data and results of the analyzing of the computer-readable data regarding the base digital image; and
producing a composite digital image having the digital sticker overlaid on the base digital image, with the producing of the composite digital image comprising overlaying the digital sticker on the base digital image.

2. The computer system of claim 1, wherein the generating of the customized digital sticker comprises generating a textual phrase, with the generating of the phrase comprising combining multiple textual portions of the phrase, and with the textual portions of the textual phrase each being a visual feature in the set of the multiple visual features that are combined in the customized digital sticker.

3. The computer system of claim 1, wherein the combining of the set of the multiple visual features in the layout of the customized digital sticker comprises overlaying one feature of the set of the multiple visual features on another feature of the set of the multiple visual features.

4. The computer system of claim 1, wherein the set of the multiple visual features combined in the customized digital sticker comprises a textual feature and a non-textual graphical feature.

5. The computer system of claim 1, wherein the analyzing of the computer-readable data regarding the base digital image comprises performing image analysis on the base digital image.

6. The computer system of claim 5, wherein performing the image analysis comprises categorizing a visual feature of the base digital image as a type of item.

7. The computer system of claim 6, wherein the visual feature of the base digital image is a human face.

8. The computer system of claim 6, wherein the image analysis comprises performing facial recognition on the visual feature of the base digital image.

9. The computer system of claim 1, wherein the computer-readable data regarding the base digital image comprises data indicating a time that the base digital image was taken as a photograph and data indicating a location where the base digital image was taken as a photograph.

10. The computer system of claim 9, wherein the additional computer-readable data comprises data that is descriptive of one or more events, which is proximate in time to the indicated time that the base digital image was taken as a photograph and proximate in location to the indicated location where the base digital image was taken as a photograph.

11. The computer system of claim 1, wherein the retrieving of the additional computer-readable data comprises retrieving the additional data from a remote computer service.

12. The computer system of claim 1, wherein the acts further comprise receiving a user input instruction to move the digital sticker relative to the base digital image in the composite digital image, and in response to the receiving of the user input instruction, moving the digital sticker relative to the base digital image in the composite digital image.

13. The computer system of claim 1, wherein the customized digital sticker is a first customized digital sticker, wherein the set of the multiple visual features is a first set of the multiple visual features, and wherein the acts further comprise:
generating a second customized digital sticker for the base digital image in response to the receiving of the request to generate one or more customized digital stickers, with the second customized sticker comprising a set of the multiple visual features, and with the generating of the second customized digital sticker comprising:
accessing the set of computer-readable sticker generation rules in the computer system, with the set of computer-readable sticker generation rules dictating a layout of a second set of the multiple visual features; and
generating the second customized digital sticker using the set of sticker generation rules, with the second generated digital sticker having the second set of the multiple visual features, with the generating of the second digital sticker comprising combining the second set of the multiple visual features in a layout that is dictated by the set of sticker generation rules, with the composite digital image comprising the first digital sticker and the second digital sticker overlaid on the base digital image, and with the producing of the composite digital image comprising overlaying the first digital sticker and the second digital sticker on the base digital image.

14. A computer-implemented method, comprising:
receiving computer-readable data regarding a base digital image;
receiving a request to generate one or more customized digital stickers for the base digital image;
in response to the request, analyzing the computer-readable data regarding the base digital image via a computer system;
in response to the request, generating, via the computer system, a customized digital sticker for the base digital image using results of the analyzing of the computer-readable data regarding the base digital image, with the customized sticker comprising multiple visual features, and with the generating comprising:
accessing a set of computer-readable sticker generation rules in the computer system that dictate a layout of the multiple visual features; and
generating the customized digital sticker using the set of sticker generation rules, with the generated digital sticker having the multiple visual features, and with the layout of the multiple visual features being dictated by the set of sticker generation rules; and
overlaying, via the computer system, the digital sticker on the base digital image to produce a composite digital image having the digital sticker overlaid on the base digital image.

15. The method of claim 14, wherein the generating of the digital sticker comprises overlaying one feature of the multiple visual features on another feature of the multiple visual features.

16. The method of claim 14, wherein the multiple visual features comprise a textual feature and a non-textual graphical feature.

17. The method of claim 14, wherein the analyzing of the data regarding the base digital image comprises categorizing a visual feature of the base digital image as a type of item.

18. The method of claim 14, wherein the analyzing of the data regarding the base digital image comprises analyzing data indicating a time that the base digital image was taken as a photograph and data indicating a location where the base digital image was taken as a photograph, wherein the generating of the digital sticker uses the data indicating the time that the base digital image was taken as a photograph and the data indicating the location where the base digital image was taken as a photograph.

19. The method of claim 14, further comprising receiving a user input instruction to move the digital sticker relative to the base digital image in the composite digital image, and in response to the receiving of the user input instruction, moving the digital sticker relative to the base digital image in the composite digital image.

20. One or more computer-readable memory having computer-executable instructions embodied thereon that, when executed by at least one processor, cause at least one processor to perform acts comprising:
receiving a base digital image, with the base digital image being a photograph;
receiving a request to generate one or more customized digital stickers for the base digital image;
analyzing the base digital image, with the analyzing comprising detecting one or more visual features of the base digital image;
generating a customized digital sticker for the base digital image in response to the receiving of the request to generate the one or more digital stickers, with the generating using results of the analyzing of the base digital image, and with the customized sticker comprising multiple visual features, and with the generating comprising:
accessing a set of computer-readable sticker generation rules in a computer system that dictate a layout of the multiple visual features of the digital sticker; and
generating the customized digital sticker using the set of sticker generation rules, with the generated digital sticker having the multiple visual features of the digital sticker, and with the generating of the digital sticker comprising combining the multiple visual features of the digital sticker in a layout that is dictated by the set of sticker generation rules; and
producing a composite digital image having the digital sticker overlaid on the base digital image, with the producing of the composite digital image comprising overlaying the digital sticker on the base digital image.
